(19) United States
(12) Patent Application Publication
(10) Pub. No.: US 2005/0226310 A1
(43) Pub. Date: Oct. 13, 2005

(54) Adhesive clinical thermometer pad and temperature measuring pad

(75) Inventors: Tsutomu Nakazawa, Isesaki-shi (JP); Motoya Sakano, Toyama-shi (JP)

Correspondence Address: WATCHSTONE P + D, 1300 EYE STREET, NW, SUITE 400 EAST, WASHINGTON, DC, 20005, US

(73) Assignee: Sanyo Electric Co., Ltd., Moriguchi-city (JP)

(21) Appl. No.: 10/948,750

(22) Filed: Sep. 24, 2004

Related U.S. Application Data
(63) Continuation-in-part of application No. PCT/JP03/03437, filed on Mar. 20, 2003.

(30) Foreign Application Priority Data
Sep. 29, 2003 (JP) 2003-338860
Mar. 20, 2002 (JP) 2002-78049

(51) Int. Cl. G01K 1/00

(52) U.S. Cl. 374/208; 374/120

(57) ABSTRACT

An adhesive clinical thermometer pad is used in combination with a reader for reading temperature information of a patient from the thermometer pad. The pad includes a flexible main body of a generally flat shape, an adhesive layer formed on a rear surface of the main body, an antenna portion for receiving a radio wave emitted from the reader, an electric power generating portion for generating electric power from the radio wave received by the antenna portion, a temperature senor for measuring a body temperature of the patient, and an output portion for wirelessly outputting temperature information toward the reader. The antenna portion, the electric power generating portion, the temperature sensor and the output portion are embedded in the main body. The temperature information includes the measured temperature and an ID code given to the clinical thermometer pad. The output portion is operated by the electric power generated by the electric power generating portion. The adhesive clinical thermometer pad attached to a skin surface of the patient via the adhesive layer receives the radio wave from the reader, generates electric power from the received radio wave, measures the body temperature of the patient and wirelessly outputs the temperature information toward the reader.

### CROSS REFERENCE TO RELATED APPLICATIONS

This is continuation-in-part of commonly assigned co-pending PCT application No. PCT/JP03/03437, filed on Mar. 20, 2003, designating the United States of America as one of designation countries and claiming the benefit of the filing date of Japanese Patent Application No. 2002-78049 filed on Mar. 20, 2002, the entire disclosures of which are incorporated herein by reference in their entireties.

This application claims priority under 35 U.S.C.§119 to Japanese Patent Application No. P2003-338860 filed on Sep. 29, 2003, the entire disclosure of which is incorporated herein by reference in its entirety.

### BACKGROUND OF THE INVENTION

1. Field of the Invention

The present invention relates to an adhesive clinical thermometer pad and a temperature measuring pad to be used in connection with a reader for reading temperature information of a patient from the thermometer pad.

2. Description of Related Art

The following description sets forth the inventor's knowledge of related art and problems therein and should not be construed as an admission of knowledge in the prior art.

For example, in hospitals, it is required for a nurse to measure body temperatures of patients to monitor their health status several times a day. In measuring the body temperatures, conventionally, mercury thermometers and/or electric thermometers are generally used. Such thermometers are delivered to respective patients to measure their body temperature. The patients measure their respective body temperatures by themselves. Then, a nurse reads respective body temperatures of the thermometers and writes down the measured values on a recording sheet and collects the thermometers. Thereafter, it is required for a nurse to sterilize the collected thermometers and then input the measured results which were once wrote down on the sheet into a personal computer.

There had been the following drawbacks in measuring patient's body temperatures in hospitals.

In most hospitals, however, in order to check the health condition of each patient, the body temperature of each patient will be measured at least three times a day, e.g., once in the morning, once at noon and once at night. In the case of using mercury thermometers, it takes a long time to complete the measurement. On the other hand, in the case of using prediction type electric thermometers, it is required to tightly fit the thermometer on a skin surface to obtain the equilibrium body temperature. Otherwise, the accuracy deteriorates.

The measured temperatures of all of the patients should be recorded on a recording sheet with a pencil or the like together with necessary information connected with the measured temperatures, e.g., the patient's name and the measured date and time. Therefore, a nurse is required to complete the recoding operation in addition to the body temperature measuring operation, causing troublesome operations. Furthermore, as mentioned above, the nurse is further required to input the measured data into a computer using a keyboard, which further increases the burden of the nurse. On the other hand, for each patient, the body temperature measuring operation was also troublesome.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide an adhesive clinical thermometer pad capable of easily and quickly measuring a body temperature of a patient in hospitals or the like.

Among other potential advantages, some embodiments can provide a temperature measuring pad capable of easily and quickly measuring a temperature of an object.

According to a first aspect of a preferred embodiment of the present invention, in an adhesive clinical thermometer pad to be used in combination with a reader for reading temperature information of a patient from the thermometer pad, the adhesive clinical thermometer pad includes:

a flexible main body of a generally flat shape;

an adhesive layer formed on a rear surface of the main body;

an antenna portion for receiving a radio wave emitted from the reader;

an electric power generating portion for generating electric power from the radio wave received by the antenna portion;

a temperature senor for measuring a body temperature of the patient; and

an output portion for wirelessly outputting temperature information toward the reader,

wherein the antenna portion, the electric power generating portion, the temperature sensor and the output portion are embedded in the main body,

wherein the temperature information includes the measured temperature and an ID code given to the temperature measuring pad, and

wherein the output portion is operated by the electric power generated by the electric power generating portion,

whereby the adhesive clinical thermometer pad attached to a skin surface of the patient via the adhesive layer receives the radio wave from the reader, generates electric power from the received radio wave, measures the body temperature of the patient and wirelessly outputs the temperature information toward the reader.

The adhesive clinical thermometer pad can further includes a memory for storing the ID code. Preferably, the memory is a rewritable memory, so that the ID code can be rewritten.

The adhesive clinical thermometer pad can further includes an A/D converter for converting an analog signal from the temperature sensor into a digital signal, and wherein the digital signal is wirelessly outputted from the output portion via the antenna.

The adhesive clinical thermometer pad can be configured to be connected to a personal computer via the reader, whereby the personal computer reads the temperature information, stores the read temperature information, processes the read temperature information and displays the processed information.

According to a second aspect of a preferred embodiment of the present invention, in a temperature measuring pad to be used in combination with a reader for reading temperature information from a temperature measuring pad, the temperature measuring pad includes:

an antenna portion for receiving a radio wave emitted from the reader;

an electric power generating portion for generating electric power from the radio wave received by the antenna portion;

a temperature senor for measuring the temperature of an object; and

an output portion for wirelessly outputting temperature information toward the reader, the temperature information including the measured temperature and an ID code given to the temperature measuring pad,

wherein the output portion is operated by the electric power generated by the electric power generating portion.

In the temperature measuring pad, the temperature measuring pad can include a flexible main body of a generally flat shape and an adhesive layer formed on a rear surface of the main body, and wherein the antenna portion, the electric generating portion, the temperature sensor and the output portion are embedded in the main body.

The temperature measuring pad can further includes an A/D converter for converting an analog signal from the temperature sensor into a digital signal, and wherein the digital signal is wirelessly outputted from the output portion via the antenna portion.

The temperature measuring pad can further include a memory for storing the ID code. Preferably, the memory is a rewritable memory.

The adhesive clinical thermometer pad can be configured to be connected to a personal computer via the reader, whereby the personal computer reads the temperature information, stores the read temperature information, processes the read temperature information and displays the processed information.

The temperature measuring pad can be used for measuring a body temperature of a patient for clinical purposes.

According to a third aspect of a preferred embodiment of the present invention, in a temperature measuring pad to be used in combination with a reader for reading temperature information from the temperature measuring pad, the temperature measuring pad includes:

an adhesive main body of a generally flat shape;

a battery;

a temperature senor for measuring a temperature of an object; and

an output portion for wirelessly outputting temperature information toward the reader, the temperature information including the measured temperature and an ID code given to the temperature measuring pad,

wherein the battery, the temperature sensor and the output portion are embedded in the main body, and

wherein the output portion is operated by the battery.

The adhesive main body can have an adhesive layer on a rear surface thereof, and wherein the battery, the temperature sensor and the output portion are embedded in the main body.

The temperature measuring pad can further include an A/D converter for converting an analog signal from the temperature sensor into a digital signal, and wherein the digital signal is wirelessly outputted from the output portion.

The temperature measuring pad can include a memory for storing the ID code. Preferably, the memory is a rewritable memory.

The temperature measuring pad can be configured to be connected to a personal computer via the reader, whereby the personal computer reads the temperature information, stores the read temperature information, processes the read temperature information and displays the processed information.

The temperature measuring pad can be used for measuring a body temperature of a patient for clinical purposes.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1A is a top view of a temperature measuring pad according to an embodiment of the present invention;

FIG. 1B is a cross-sectional view taken along the line 1-1 in FIG. 1A;

FIG. 2 is a block diagram of the pad;

FIG. 3 shows an illustrative comprehensive temperature measuring system related to some embodiments of the present invention;

FIG. 4 is a block diagram of a reader (receiving portion) and that of an adhesive temperature measuring pad (transmitting portion) of the temperature measuring system;

FIG. 5 is a flowchart of the operation of the system;

FIG. 6 is a block diagram of the reader (receiving portion) and that of a computer connected to the reader;

FIG. 7 is an example of data stored in the computer;

FIG. 8A is an organized data displayed on a screen of the computer;

FIG. 8B is a graph of the organized data displayed on the screen of the computer;

FIG. 9 shows a state in which an ID code of the adhesive temperature pad is being rewritten; and

FIG. 10 is a block diagram of the system shown in FIG. 9.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

A preferable embodiment of the present invention will be explained with reference to the attached drawings. The following explanation will be directed to an adhesive clinical thermometer pad used for measuring body temperatures of patients in hospitals. However, it should be understood that the present invention is not limited to the above and can also be applied to various applications required to measure a surface temperature of an object in various industries.

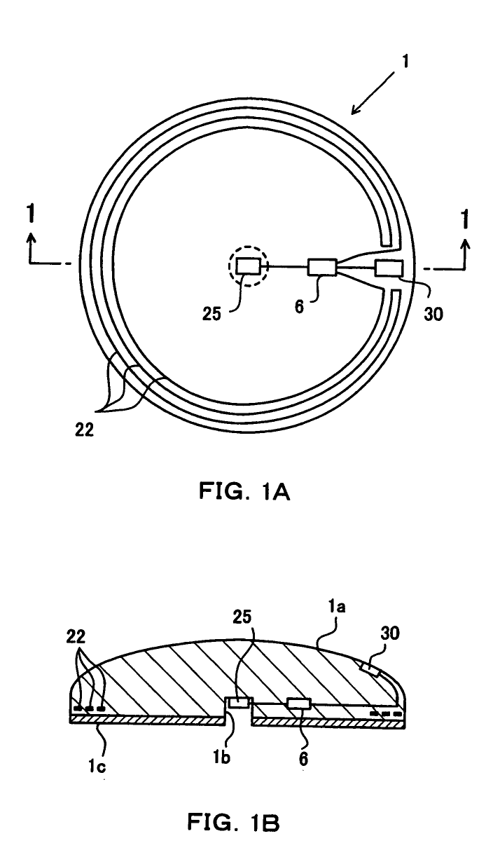

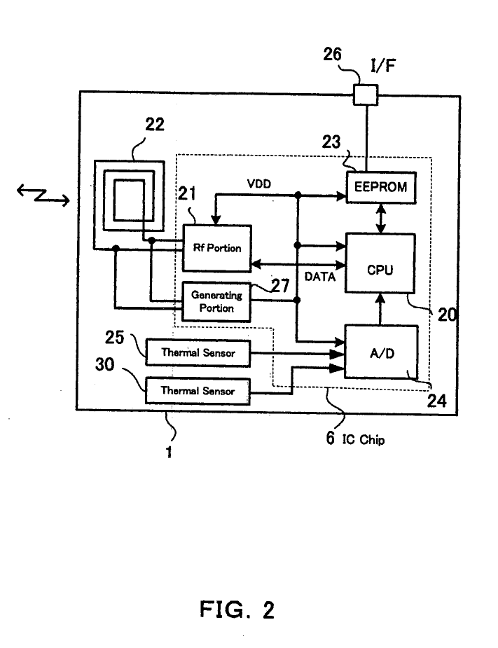

FIG. 1 is a schematic view showing an adhesive clinical thermometer pad (temperature measuring pad) of the embodiment. The top view of the pad 1 is shown in FIG. 1A and the cross-sectional view taken along the line 3-3 in FIG. 1A is shown in FIG. 1B. FIG. 2 shows a block diagram of this pad 1. This thermometer pad 1 is used in combination with a reader 2 in a temperature measuring system shown in FIG. 2.

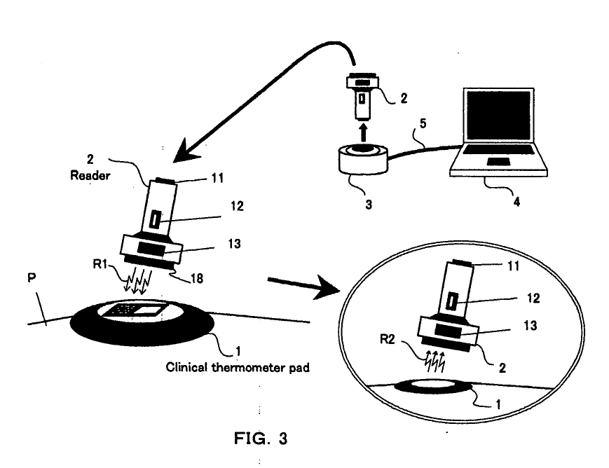

As shown in FIG. 3, the adhesive clinical thermometer pad 1 is attached to a skin surface of a patient for measuring the body temperature. This thermometer pad 1 is used in combination with a reader 2 for reading the temperature information from the thermometer pad 1 and storing the temperature information therein. The reader 3 is configured so as to be detachably plugged into a socket 3 having a charge function to be connected to the personal computer 4 via a cable 5 so that data processing can be performed by the personal computer 4.

In this embodiment, the clinical thermometer pad 1 attached to a skin surface of a patient P receives a radio wave R1 emitted from the reader 2 and generates electric power from the received radio wave R1 by itself, and measures the body temperature using the self-generated electric power. The measured temperature data will be transmitted as a radio wave R2 from the clinical thermometer pad 1 to the reader 2 together with a given identification code (hereinafter referred to as “ID code”) of the clinical thermometer pad 1, and then stored in the reader 2. After completing the temperature measurement, the reader 2 is plugged into the socket 3 to be connected to the personal computer 4 via the cable 5. The personal computer 4 reads the temperature information from the reader 2 and performs various data processing depending on need.

FIG. 2 shows a block diagram of the adhesive clinical thermometer pad 1. As shown in FIG. 2, the adhesive clinical thermometer pad 1 includes an IC chip 6, a temperature sensor (e.g., thermistor) 25, an antenna 22, an external interface I/F 26 and an external temperature sensor (thermistor) 30. The aforementioned IC chip 6 includes a CPU 20, an EEPROM 23 storing an ID code of the adhesive clinical thermometer pad 1 and programs, an A/D converter (hereinafter simply referred to as “A/D”), an RF portion 21 and a power generation circuit 27 for generating electric power by rectifying the RF carriers of the radio wave received by the antenna 22.

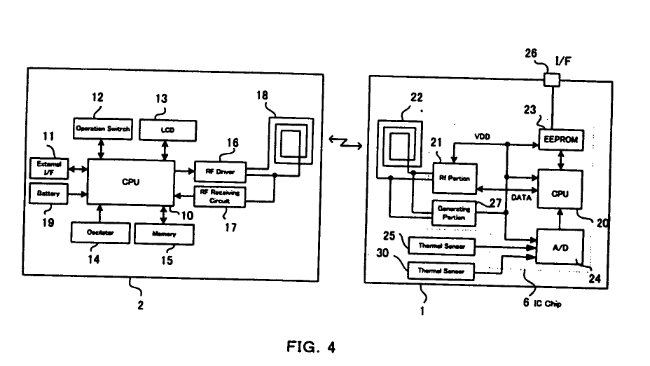

FIG. 4 shows a block diagram of the entire system including the aforementioned block diagram of the adhesive clinical thermometer pad 1. As shown in the left side block diagram in FIG. 4, the reader 2 includes a processor 10 (hereinafter referred to as “CPU”) for entirely controlling the reader 2, an external interface 11 (hereinafter referred to as “I/F”) for exchanging data between the reader 2 and an external personal computer 4, an operation switch 12 for operating the reader 2, a liquid crystal display (LCD) 13, an oscillator 14 for a system clock and a clock function, a memory 15 for temporarily storing received data, an RF driver 16 including a resonant circuit, an RF receiving circuit 17, and antenna 18 for emitting a radio wave and receiving the temperature information from the adhesive clinical thermometer pad 1.

In measuring the body temperature using the aforementioned system, as shown in FIG. 3, the reader 2 is unplugged from the socket 3 by which the reader 2 was being charged. Then, the reader 2 is brought close to the adhesive clinical thermometer pad 1 attached to the skin surface of a patient P. In this state, when the operation switch 12 is turned on, the reader 2 emits a 13.56 MHz weak radio wave R1 in the order of approximately 10 mW via the antenna 18 toward the adhesive clinical thermometer pad 1. The adhesive clinical thermometer pad 1 adhering to the skin surface of the patient P receives the radio wave and rectifies the RF carriers of the radio wave R1 to thereby generate electric power. The IC chip 6 embedded in the pad 1 capable of being operated by the generated electric power measures the body temperature with the temperature sensor 25.

The measured body temperature data is wirelessly transmitted as a radio wave R2 together with the ID data of the adhesive clinical thermometer pad 1 stored in the EEPROM 23 in the IC chip 6 via the RF portion 21 and the antenna 22.

The reader 2 receives the radio wave R2 including the body temperature data wirelessly transmitted from the antenna 22 of the adhesive clinical thermometer pad 1, and then converts the temperature data into digital data. The digitalized data of the body temperature information will be stored in the memory 15 with the time data related to the body temperature data. The reader 2 can have an alarm function that discriminates whether the body temperature exceeds a predetermined temperature and sounds an alarm when it is discriminated that the body temperature exceeds the predetermined temperature.

When the reader 2 is plugged into the socket 3 connected to the personal computer 4 via the cable 5, the information including the body temperature and the ID code of the pad 1 and the measured date and time is transmitted to the personal computer 4 via the cable 5, and then stored in a hard disk HDD. Thus, a series of operations for measuring body temperature, recording the body temperature and storing the temperature information are completed.

The temperature sensor 25 can be any means capable of converting a detected temperature into an electric resistance. Examples thereof include a thermistor chip and a thermistor pattern printed on a film-like substrate. The temperature sensor 25 embedded in the measuring pad 1 directly or indirectly adheres to the skin surface of the patient P for a long time period. Accordingly, the actual and accurate body temperature can be quickly measured without requiring any prediction time which is usually required in a normal prediction type clinical thermometer. This remarkably reduces measurement errors.

As shown in FIG. 1, the adhesive clinical thermometer pad 1 is formed into a generally round disk shape. The main body 1a is made of, for example, polyurethane foam. The bottom surface in the central portion of the main body 1a is provided with a dented portion 1b having a certain depth. In the bottom of this dented portion 1b, the thermistor chip 25 (temperature sensor) is disposed so that the thermistor chip 25 can be isolated from the outside air. This thermistor chip 25 detects indirectly the body temperature of the patient in the sate in which the pad 1 adheres to a skin surface of a patient. Since the thermistor chip 25 is thermally insulated from the external air, it becomes possible to measure the body temperature more accurately.

Also embedded in the main body 1a are an antenna 22 and the IC chip 6. The antenna 22 is formed into a circular shape along the periphery of the main body 1a. The shape and the structure of the antenna 22 are not limited to the above, and can be any shape and structure. The pad 1 is further provided with an additional thermistor 30 for measuring an external temperature. This additional thermistor 30 is arranged at the upper surface side of the main body 1a so as to be exposed to the external air. By considering the external temperature measured with this thermistor 30, the body temperature measured with the thermistor chip 25 can be amended so as to obtain accurate body temperature of the patient. On the bottom surface of the main pad 1a, an adhesive layer 1b is formed so that the entire pad 1 can immovably adhere to a skin surface of a patient. In place of forming the aforementioned adhesive layer 1c, an adhesive tap (not shown) can be provided on the bottom surface of the main body 1a. Alternatively, another means for adhering the pad 1 to a skin surface of a patient can be employed.

In the above-explained embodiment, although the adhesive clinical thermometer pad 1 is formed into a round shape with a relatively large thickness, the structure of the adhesive clinical thermometer pad 1 is not limited to the above. In place of the above, the structure disclosed in PCT/JP03/03437 and Unexamined Japanese Laid-open Patent Publication No. 2003-270051 can also be employed, and the disclosures thereof are incorporated herein in their entireties.

It should be understood that in this disclosure the wording of “pad” does not always mean a “relatively thick cushionlike member made of soft material” as shown in FIG. 1, but also means any other various members such as a sheet-like member, a film-like member, a patch-like member, a plate-like member or a belt-like member. Among other things, it is preferable that the clinical thermometer pad 1 is a soft and flexible flattened member capable of fitting to a skin surface of a human body along the curvature thereof.

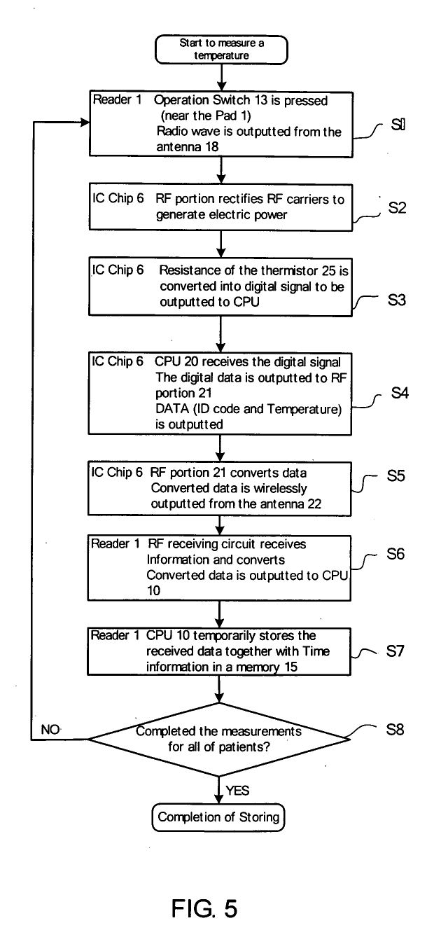

The operation of this temperature measuring system will be explained based on the flowchart shown in FIG. 5. In this disclosure, “Step” may be simply referred to as “S.”

Initially, the operation switch 12 of the reader 2 is turned on near the adhesive clinical thermometer pad 1 to output a weak radio wave in the order of 10 mW generated in the RF driver 16 from the antenna 18 (Step S1).

The radio wave is received by the antenna 22 of the adhesive clinical thermometer pad 1 and introduced into the RF portion 21 of the IC chip 6. The RF portion 21 rectifies the RF carrier of the radio wave to generate the electric power, i.e., power-supply voltage VDD, which is supplied to the entire portion of the IC chip 6 (Step S2).

The temperature sensor 25, or a thermistor 25 which varies in electric resistance in accordance with the body temperature of a human body, converts the electric resistance thereof into a voltage. The voltage is applied to the A/D converter 24 in which the voltage is converted into digital data, and then the digital data is outputted to the CPU 20 (Step S3).

The CPU 20 receives the digital data and makes a resister store the data. The CPU 20 outputs digital data temporarily stored in the resister to the RF portion 21 with the ID code previously written in the EEPROM 23 associated with the digital data (Step S4).

The RF portion 21 converts the digital data into a wireless temperature data and then wirelessly outputs the temperature data via the antenna 22 (Step S5).

On the other hand, in the reader 2, the RF receiving circuit 17 wirelessly receives the temperature data from the pad 1 via the antenna 18 and then converts the data into digitalized temperature data and outputs the data to the CPU 10 (Step S6).

The CPU 10 makes the memory 15 store the digitalized temperature data together with the current time information (Step S7).

Thus, the processing from the measurement of body temperature to the recordation of temperature information for a single person (patient) is completed. Then, it is discriminated whether processing for all persons (patients) is completed (Step S8).

If it is discriminated that processing for all persons (patients) is completed, the job terminates. To the contrary, if it is discriminated that processing for all persons (patients) is not completed, the routine returns to Step S1 to repeat the aforementioned steps from Step S1 to Step S8.

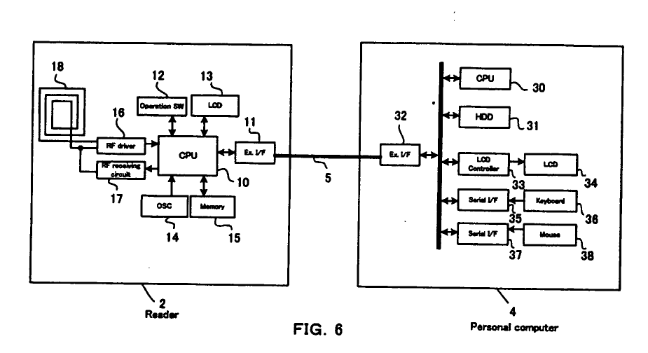

FIG. 6 shows a block diagram of the reader 2 and that of the computer 4 connected thereto via the wire 5 in a state in which the reader 2 is plugged into the socket 3. Since the block diagram of the reader 2 is the same as that of the reader shown in FIG. 4, the explanation will be omitted by allotting the same reference numerals to the corresponding portions. In the right side block diagram showing the computer 4, reference numeral “30” denotes a CPU capable of executing an operation system (hereinafter referred to as “OS”), “31” denotes a hard disk (hereinafter referred to as “HDD”) capable of storing various application software and the data from the reader 2, “32” denotes an external I/F such as a USB port connected to the internal bus, “33” denotes an LCD controller, “34” denotes an LCD monitor, “35” denotes a serial I/F, “36” denotes a key board connected to the serial I/F 35, “37” denotes a serial I/F, “38” denotes a mouse connected to the serial I/F 37.

When the reader 2 is plugged into the socket 3 after the completion of measurements for all of the patients, the data stored in the memory 15 is transmitted from the external I/F 11 to be transferred to the personal computer 4 via the cable 5. In the personal computer 4, the data is received by the external I/F 32 and then transferred to the HDD 31. This HDD 31 stores the data (including data of the ID of each patient, the body temperature, and the measured time and date).

In this embodiment, the data transfer from the reader 3 to the computer 4 is performed via the cable 5 (i.e., a cable communication). In place of such a cable communication for the data transfer, a known wireless communication method can be employed.

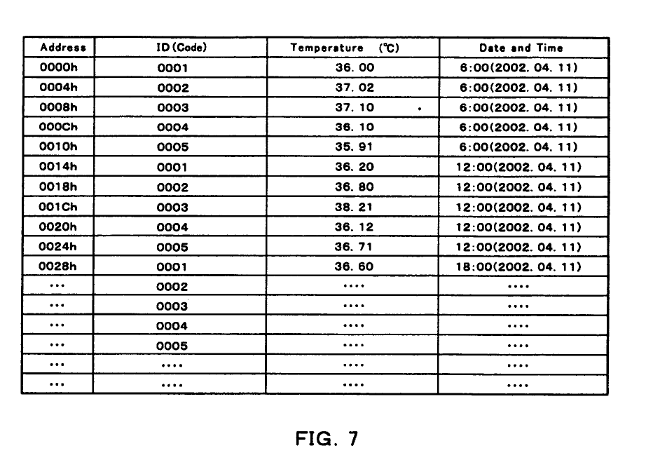

FIG. 7 shows the temperature information data stored in the HDD 31. The data constitutes a database including the data of the ID code, the measured body temperature and the measured time and date stored in this order every the patient. The data contained in this database can be utilized using application software capable of being operated by the CPU 30.

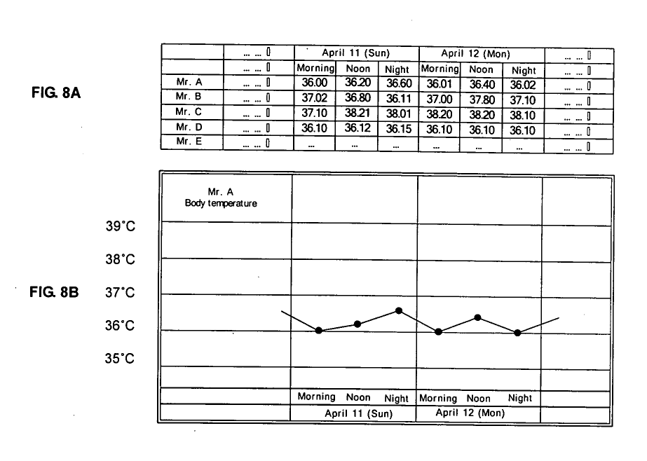

An example of utilizing the database is shown in FIG. 8. FIG. 8A shows a table displayed on the monitor of the computer 4 in which the two-day-history of the body temperatures of each patient measured three times a day is displayed. This history can be displayed as a graph shown in FIG. 8B for example. The graph can be displayed as a unit such as a one-day-history, a three-day-history, or a one-week-history, which is useful for a nurse to easily and visually grasp the status of each patient.

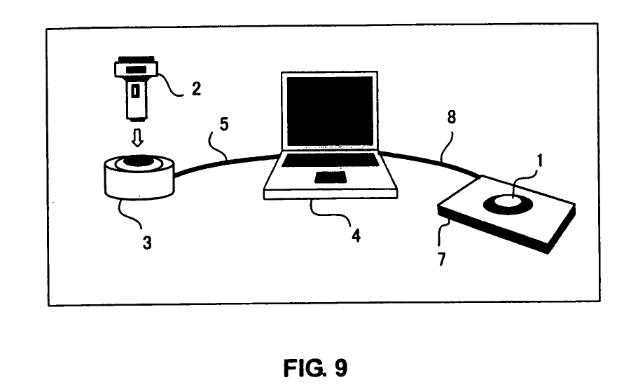

As mentioned above, the aforementioned adhesive clinical thermometer pad 1 stores the ID code given to each pad 1 which is exclusively used for a certain patient. Therefore, each ID code corresponds to each patient. In cases where the pad 1 is used by another patient, the ID code should be changed. Accordingly, in this embodiment, as shown in FIG. 9, the system further includes an ID rewriting table 7 for rewriting the ID code of each pad 1 stored in the EEPROM 23. The rewriting table 7 is connected to the personal computer 4 via a cable 8.

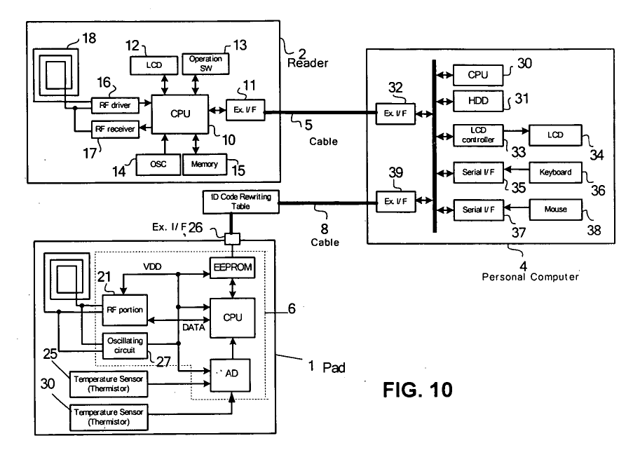

In rewriting the ID code of the pad 1, the pad 1 is disposed on the table 7 with the external I/F 26 of the pad 1 connected to the table 7, and then the rewriting table 7 is operated by the personal computer 4. Thus, the ID code stored in the EEPROM 23 of the pad 1 can be easily rewritten. The block diagram showing the connected status is shown in FIG. 10. Since the structures thereof are the same as those shown in FIG. 1, the detail explanation of this block diagram will be omitted by allotting the same reference numerals to the corresponding portions.

In the aforementioned embodiment, the electric power for driving the IC chip 6 of the pad 1 is generated by rectifying the RF carriers of the radio wave emitted from the reader 6 and received by the pad 1. In this invention, however, a battery (not shown) can be used for driving the IC chip 6.

Furthermore, although the temperature measuring system in the aforementioned embodiment is used for the clinical purposes in hospitals, the system can also be applied to various fields for measuring a surface temperature of an object.

Concepts, features and specific embodiments of a temperature measuring device and method disclosed in PCT/JP03/03437, filed on Mar. 20, 2003, can also be applied to the adhesive clinical thermometer pad and the temperature measuring pad according to the present invention, and therefore the entire disclosure thereof is incorporated herein by reference in its entirety.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

1. An adhesive clinical thermometer pad to be used in combination with a reader for reading temperature information of a patient from the thermometer pad, the adhesive clinical thermometer pad, comprising:
a flexible main body of a generally flat shape;
an adhesive layer formed on a rear surface of the main body;
an antenna portion for receiving a radio wave emitted from the reader;
an electric power generating portion for generating electric power from the radio wave received by the antenna portion;
a temperature senor for measuring a body temperature of the patient; and
an output portion for wirelessly outputting temperature information toward the reader,
wherein the antenna portion, the electric power generating portion, the temperature sensor and the output portion are embedded in the main body,
wherein the temperature information includes the measured temperature and an ID code given to the clinical thermometer pad, and
wherein the output portion is operated by the electric power generated by the electric power generating portion,
whereby the adhesive clinical thermometer pad attached to a skin surface of the patient via the adhesive layer receives the radio wave from the reader, generates electric power from the received radio wave, measures the body temperature of the patient and wirelessly outputs the temperature information toward the reader.

2. The adhesive clinical thermometer pad as recited in claim 1, further comprising a memory for storing the ID code.

3. The adhesive clinical thermometer pad as recited in claim 2, wherein the memory is a rewritable memory.

4. The adhesive clinical thermometer pad as recited in claim 1, further comprising an A/D converter for converting an analog signal from the temperature sensor into a digital signal, and wherein the digital signal is wirelessly outputted from the output portion via the antenna.

5. The adhesive clinical thermometer pad as recited in claim 1, wherein the adhesive clinical thermometer pad is configured to be connected to a personal computer via the reader, whereby the personal computer reads the temperature information, stores the read temperature information, processes the read temperature information and displays the processed information.

6. A temperature measuring pad to be used in combination with a reader for reading temperature information from a temperature measuring pad, the temperature measuring pad, comprising:
an antenna portion for receiving a radio wave emitted from the reader;
an electric power generating portion for generating electric power from the radio wave received by the antenna portion;
a temperature senor for measuring the temperature of an object; and
an output portion for wirelessly outputting temperature information toward the reader, the temperature information including the measured temperature and an ID code given to the temperature measuring pad,
wherein the output portion is operated by the electric power generated by the electric power generating portion.

7. The temperature measuring pad as recited in claim 6, wherein the temperature measuring pad includes a flexible main body of a generally flat shape and an adhesive layer formed on a rear surface of the main body, and wherein the antenna portion, the electric generating portion, the temperature sensor and the output portion are embedded in the main body.

8. The temperature measuring pad as recited in claim 6, further comprising an A/D converter for converting an analog signal from the temperature sensor into a digital signal, and wherein the digital signal is wirelessly outputted from the output portion via the antenna portion.

9. The temperature measuring pad as recited in claim 6, further comprising a memory for storing the ID code.

10. The temperature measuring pad as recited in claim 9, wherein the memory is a rewritable memory.

11. The temperature measuring pad as recited in claim 6, wherein the adhesive clinical thermometer pad is configured to be connected to a personal computer via the reader, whereby the personal computer reads the temperature information, stores the read temperature information, processes the read temperature information and displays the processed information.

12. The temperature measuring pad as recited in claim 6, wherein the temperature measuring pad is used for measuring a body temperature of a patient for clinical purposes.

13. A temperature measuring pad to be used in combination with a reader for reading temperature information from the temperature measuring pad, the temperature measuring pad, comprising:
an adhesive main body of a generally flat shape;
a battery;
a temperature senor for measuring a temperature of an object; and
an output portion for wirelessly outputting temperature information toward the reader, the temperature information including the measured temperature and an ID code given to the temperature measuring pad,
wherein the battery, the temperature sensor and the output portion are embedded in the main body, and
wherein the output portion is operated by the battery.

14. The temperature measuring pad as recited in claim 13, wherein the adhesive main body has an adhesive layer on a rear surface thereof, and wherein the battery, the temperature sensor and the output portion are embedded in the main body.

15. The temperature measuring pad as recited in claim 13, further comprising an A/D converter for converting an analog signal from the temperature sensor into a digital signal, and wherein the digital signal is wirelessly outputted from the output portion.

16. The temperature measuring pad as recited in claim 13, further comprising a memory for storing the ID code.

17. The temperature measuring pad as recited in claim 16, wherein the memory is a rewritable memory.

18. The temperature measuring pad as recited in claim 13, wherein the temperature measuring pad is configured to be connected to a personal computer via the reader, whereby the personal computer reads the temperature information, stores the read temperature information, processes the read temperature information and displays the processed information.

19. The temperature measuring pad as recited in claim 13, wherein the temperature measuring pad is used for measuring a body temperature of a patient for clinical purposes.
